(19) United States
(12) Patent Application Publication
(10) Pub. No.: US 2008/0036108 A1
(43) Pub. Date: Feb. 14, 2008

(54) Molding system having thermal-management system, amongst other things

(75) Inventor: Robert Domodossola, Brampton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/503,025

(22) Filed: Aug. 11, 2006

(51) Int. Cl. B29C 45/73

(52) U.S. Cl. 264/40.6; 425/144; 425/552; 264/328.16

(57) ABSTRACT

Disclosed is: (i) a thermal management system of a molding system, (ii) a molding system having a thermal management system, and/or (iii) a method of a molding system having a thermal management system, amongst other things.

### TECHNICAL FIELD

The present invention generally relates to, but is not limited to, molding systems, and more specifically the present invention relates to, but is not limited to, (i) a thermal management system of a molding system, (ii) a molding system having a thermal management system, and/or (iii) a method of a molding system having a thermal management system, amongst other things.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. No. 4,390,485 (Inventor: Yang; Published: 1983 Jun. 28) discloses a process for quickly manufacturing injection molded foamed resin products with a smooth surface finish. The process includes: (i) closing the injection mold, (ii) applying high current low voltage electric power to a heater band on the surface of the mold cavity to substantially increase the mold surface temperature within a matter of seconds or less in those portions of the mold cavity covered by the heater band, (iii) disconnecting the high current low voltage electric power from the heater band, (iv) injecting a molten formable resin into the mold cavity, the formable resin thereupon expanding against the hot heater band, (v) reducing the temperature of the resin in the mold cavity below the heat distortion temperature of the resin by cooling the mold and heater band, and, (vi) opening the injection mold and removing the plastic product.

U.S. Pat. No. 4,710,121 (Inventor: Hehl; Published: 1987 Dec. 01) discloses a mold closing unit for an injection molding machine that has an exchangeable injection mold assembly, a mold exchanging device, a conditioning table situated adjacent a clamping space of the mold closing unit; and a supply line coupling for connecting to and disconnecting from, one another conduit terminals of mold-side supply conduits and machine-side supply conduits. The supply line coupling is formed of a mold-side coupling half fixedly attached to the mold body and a machine-side coupling half arranged to be movable between the conditioning table and the clamping space. The mold-side coupling half and the machine-side coupling half are joinable to and disconnectable from, one another along a horizontal parting plane of the supply line coupling for joining the machine-side and mold-side conduits to one another for preheating the injection mold assembly on the conditioning table. There is further provided a coupling drive mounted on the machine-side coupling half for performing coupling strokes of the supply line coupling. Vertically oriented coupling pins guide the machine-side coupling half and are arranged to alternatingly engage behind a holding element of the conditioning table and the mold-side coupling half dependent on a conveying motion of the injection mold assembly.

U.S. Pat. No. 4,963,312 (Inventor: Muller; Published: 1990 Oct. 16) discloses an injection molding method for plastic materials, The method includes the steps of: (i) providing an injection mold defining a cavity, (ii) raising the temperature of the injection mold above the melting point of the plastic material before injecting the plastic material by circulating a heat carrier through the injection mold, (iii) shutting off the flow of the heat carrier through the injection mold upon injection of plastic material into the injection mold, and (iv) cooling the injection mold to a temperature below the freezing point of the plastic material by circulating the heat carrier after the cavity is filled with injected plastic material.

U.S. Pat. No. 5,182,117 (Inventor: Ozawa et al; Published: 1993 Jan. 26) discloses, in a heating/cooling unit for selectively heating or cooling a set of dies, oil received in a reservoir that is supplied to a flow direction changeover valve by a first oil pump. In a stably mode, oil is returned to the reservoir through the changeover valve and a heat exchanger. In a heating mode, the oil is supplied to a second oil pump from the changeover valve through a check valve. The second oil pump supplies the oil to an oil heater, and the heated oil is introduced into a fluid path formed in the dies to heat the dies. The oil discharged from the fluid path of the dies is returned to the second oil pump. Thus, the heated oil is circulated in a closed loop in the heating mode. In a cooling mode, new oil is supplied to the fluid path of the dies from the changeover valve and the oil discharged from the fluid path is guided to the heat exchanger through a switching valve and the cooling oil is returned to the reservoir.

United States Patent Application No. 2004/0020628 (Inventor: Suzuki et al; Published: 2004 Feb. 05) discloses a mold for molding a metallic product. The mold includes a fixed mold section and a movable mold section defining a cavity. When the both are closed together, to be filled with molded metal, the fixed mold section is provided with heating means and the movable mold section is provided with cooling means, both of which means are controlled by temperature control means, respectively, so that the temperature variations in one cycle of the fixed and movable mold sections are individually controllable.

United States Patent Application No. 2005/0276875 (Inventor: Lee; Published: 2005 Dec. 15) discloses a mold apparatus, having: (i) at least a pair of molds formed with a cavity, (ii) at least one pipe accommodator formed in the molds, (iii) at least one heat pipe mounted in the pipe accommodator, (iv) a heat-cool source part connected to the heat pipe, to heat and cool the heat pipe, and (v) a controller to control the heat-cool source part to selectively heat and cool the heat pipe.

U.S. Pat. No. 7,025,116 (Inventor: Suzuki et al; Published: 2006 Apr. 11) discloses a mold for molding a metallic product. The mold includes: (i) a fixed mold defining a fixed cavity, the fixed cavity defining a first portion of the metallic product, (ii) a movable mold defining a movable cavity, the movable cavity defining a second portion of the metallic product, the movable mold being movable with respect to the fixed mold to allow removal of the metallic product, (iii) the fixed mold section is provided with only heating means and the movable mold section is provided with only cooling means, both means being controlled by temperature control means, respectively, so that temperature variations of the fixed and movable mold sections are individually controllable, the fixed mold section is disposed on an injection side of molten metal to be molded, and the temperature control means controls the temperature of the movable mold section in a range from a solidifying point of the molten metal to 0° C. when the mold is open and controls the temperature of the fixed mold section higher than the temperature of the movable mold section when the mold is open.

### SUMMARY

According to a first aspect of the present invention, there is provided, for a molding system, a thermal management system, including a thermolator trackable of a movement of a movable platen, the thermolator configured to heat a movable-mold portion supportable by the movable platen.

According to a second aspect of the present invention, there is provided a molding system, including an extruder, a machine nozzle operatively mounted to the extruder, a stationary platen cooperative with the extruder, a movable platen movable relative to the stationary platen, a mold, the mold including a stationary-mold portion mounted to the stationary platen, and the mold also including a movable-mold portion mounted to the movable platen, the movable-mold portion and the stationary-mold portion defining a mold cavity, the movable-mold portion defining a gate leading to the mold cavity, the gate mating with the machine nozzle of the extruder, and the molding system also including a thermal management system, including a thermolator trackable of a movement of a movable platen, the thermolator configured to heat the movable-mold portion.

According to a third aspect of the present invention, there is provided a method including tracking a thermolator to a movement of a movable platen, the thermolator configured to heat a movable-mold portion supportable by the movable platen.

A technical effect, amongst other technical effects, of the aspects of the present invention is improved thermal management of a system, and in particular of a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a molding system according to a first exemplary embodiment (which is the preferred embodiment);

FIG. 2 is a schematic representation of a molding system according to a second exemplary embodiment;

FIG. 3 is another schematic representation of the molding system of FIG. 1; and

FIG. 4 is yet another schematic representation of the molding system of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

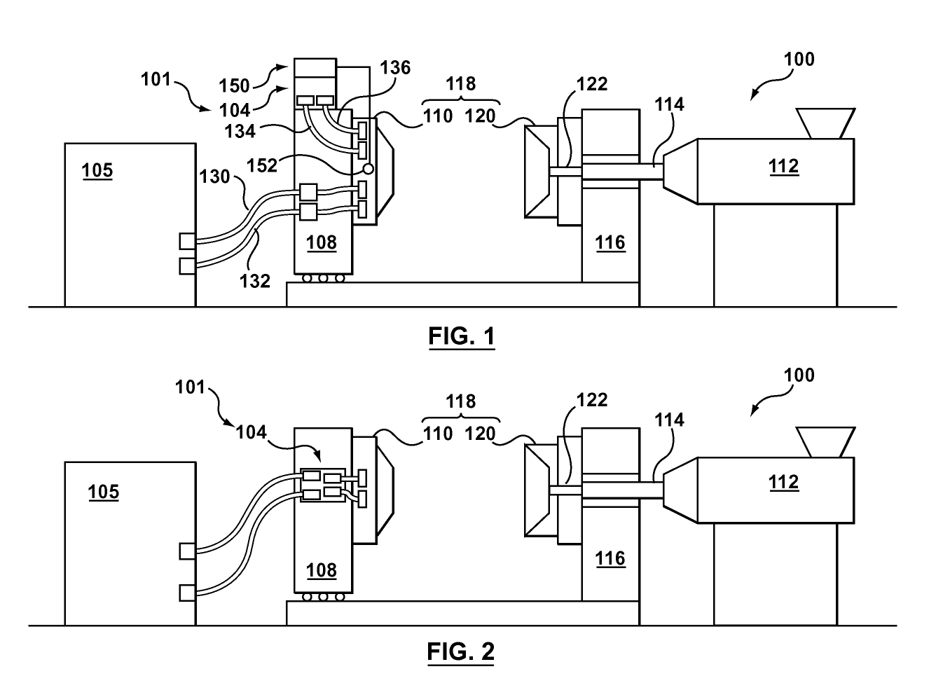

FIG. 1 is the schematic representation of a molding system 100 (hereafter referred to as the “system 100”) having a thermal management system 101 both according to the first exemplary embodiment (which is the preferred embodiment). The system 100 includes (i) an extruder 112, (ii) a machine nozzle 114 that is operatively mounted to the extruder 112, (iii) a stationary platen 116 that is cooperative with the extruder 112; the machine nozzle 114 slides through the platen 116, and (iv) a movable platen 108 that is movable relative to the stationary platen 116. The system 100 also includes (v) a mold 118. The mold 118 has a stationary-mold portion 120 that is mounted (or mountable) to the stationary platen 116. The mold 118 also has a movable-mold portion 110 that is mounted to the movable platen 108. The movable-mold portion 110 and the stationary-mold portion 120 defines a mold cavity 119 (see FIG. 4) once the mold portions 120, 110 are brought together (as a result of stroking the movable platen 108). The stationary-mold portion 120 defines a gate 122 that leads to the mold cavity 119. The gate 122 mates with the machine nozzle 114 of the extruder 112. The system 100 also includes tie bars and clamping mechanisms that are not depicted because these items, amongst other items, are known to persons skilled in the art of molding systems, and as such these items, components, sub-systems of the system 100, etc, will not be described and depicted.

The system 100 also includes the thermal management system 101. The thermal management system 101 has a thermolator 104. The thermolator 104 is trackable of a movement of the movable platen 108. The thermolator 104 is configured to manage heating of the movable-mold portion 110.

Preferably, the thermolator 104 is fixedly mounted to the movable platen 108. According to a variant, the thermolator 104 is mounted to the movable mold portion 110. A thermal-management fluid is fluidly communicable between the thermolator 104 and the movable-mold portion 110. The thermolator 104 is actuated to maintain thermal control (management) of the movable-mold portion 110 based on a closed loop control schema of a controller 150 of the thermolator 104. The controller 150 has an input that is connectable to a temperature sensor 152 that is connected to the movable-mold portion 110. A thermal-management fluid (oil, etc) is fluidly communicable between (i) the thermolator 104 and the movable-mold portion 110, and (ii) the movable-mold portion 110 and a heat-exchange reservoir 105. The heat-exchange reservoir 105 is configured to pump heat into the movable-mold portion 110. The heat-exchange reservoir 105 is disconnected from the thermolator 104 once the movable-mold portion 110 reaches a temperature elevated above ambient temperature. The thermolator 104 is also configured to maintain thermal condition of the movable-mold portion 110 once the heat-exchange reservoir 105 is disconnectable from the thermolator 104. The thermolator 104 can also be actuated to actively cool down the movable-mold portion 110 if so required.

Hoses 130, 132 are used to fluidly communicate the thermal-management fluid (such as oil, etc) between the heat-exchange reservoir 105 and the movable mold portion 110. The hose 130 is used to communicate fresh fluid from the heat-exchange reservoir 105 to the movable mold portion 110 while the hose 132 is used to communicate exhaust fluid from the movable mold portion 110 to the heat-exchange reservoir 105. The hoses 130, 132 are made of (preferably) a flexible, polymeric material or of flexible steel tubing, etc. the heat-exchange reservoir 105 is used to heat the movable mold portion 110 from ambient temperature to either at operating temperature or to near operating temperature. Most polymeric-based hoses have an upper limit of 260 degrees centigrade before they will deteriorate. If the temperature of the thermal-management fluid is intended to reach over 260 degrees centigrade, the flexible steel tubing is recommended for the hoses 130, 132.

Hoses 134, 136 are used to fluidly communicate a thermal-management fluid (such as oil, etc) between the thermolator 104 and the movable mold portion 110. The hose 134 is used to communicate fresh fluid from the thermolator 104 to the movable mold portion 110 while the hose 136 is used to communicate exhaust fluid from the movable mold portion 110 to the thermolator 104. The hoses 134, 136 are made of any one of: (i) (preferably) stiff, metallic tubing, (ii) a flexible, polymeric material or (iii) flexible steel tubing, etc. The thermolator 104 is used to maintain the thermal condition of the movable-mold portion 110 once the movable-mold portion 110 reaches its operating temperature or near-operating temperature (by usage of the heat-exchange reservoir 105).

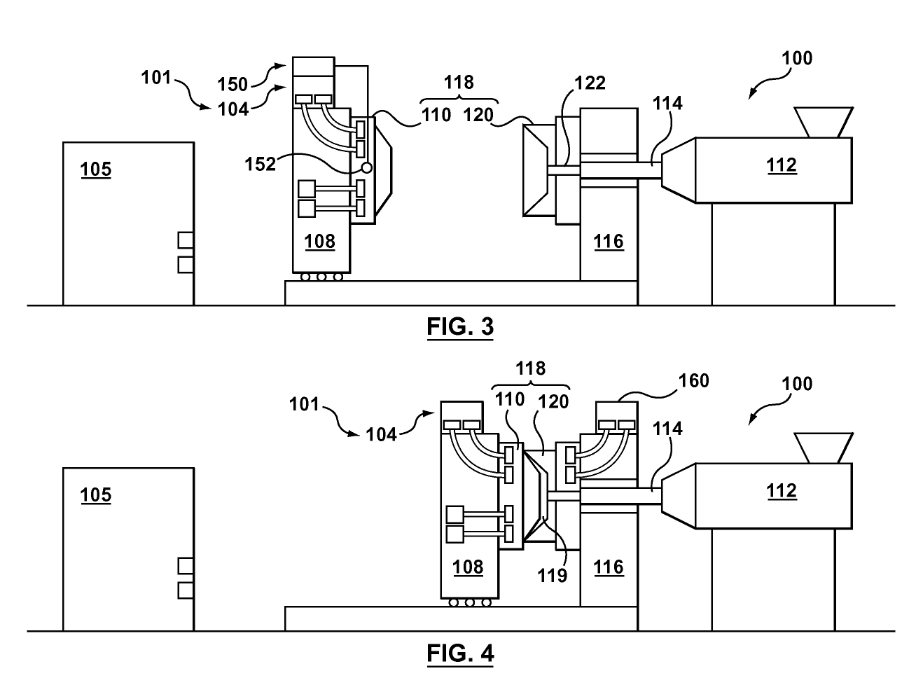

The heat-exchange reservoir 105 is used to bring the thermal condition (or temperature) of the movable-mold portion 110 from ambient temperature to rated thermal condition or temperature. Once the movable-mold portion 110 has reached the rated thermal condition, the heat-exchange reservoir 105 may be disconnected from the movable-mold portion 110 (as depicted in FIGS. 3 and 4); then, the thermolator 104 is actuated to maintain or manage the thermal condition of the movable-mold portion 110 going forward. The heat-exchange reservoir 105 may then be moved to, connected and then used to pump heat into another mold of another molding system (not depicted). The thermolator 104 is a smaller unit (relative to the reservoir 105) that has sufficient ability to maintain the thermal condition of movable-mold portion 110, while the heat-exchange reservoir 105 is large enough to quickly pump heat into the movable-mold portion 110. The heat-exchange reservoir 105 is used to pump heat into the movable-mold portion 110 from ambient temperature to a higher temperature (preferably, quickly), while the thermolator 104 is used to maintain the thermal condition of the movable-mold portion 110 once the movable-mold portion 110 reaches the higher temperature. Also, the reservoir 105 may be used to quickly lower the temperature of the movable mold 110 in order to permit faster servicing of the mold 110, etc (if so required). A technical effect of this arrangement is a reduction in cost of the system 100, in that the heat-exchange reservoir 105 may be shared amongst other molding systems. It will be appreciated that another thermal-management unit (not depicted) may be mounted to the stationary platen 116 and used to manage the thermal condition of the stationary-mold portion 120.

FIG. 2 is the schematic representation of the system 100 according to the second exemplary embodiment, in which the connections of the heat-exchange reservoir 105 are couplable to the thermolator 104. According to the second exemplary embodiment, the heat-exchange reservoir 105 is fluidly coupled to the thermolator 104, and the thermolator 104 is coupled to the movable-mold portion 110. The thermal-management fluid is fluidly communicable between (i) the thermolator 104 and the movable-mold portion 110, and (ii) the thermolator 104 and the heat-exchange reservoir 105. The heat-exchange reservoir 105 is configured to pump heat into the movable-mold portion 110, via the thermolator 104. The heat-exchange reservoir 105 is disconnected from the thermolator 104 once the movable-mold portion 110 reaches a temperature elevated above ambient temperature (such as, 250 degrees Centigrade). The thermolator 104 is configured to manage thermal condition of the movable-mold portion 110 once the heat-exchange reservoir 105 is disconnected from the thermolator 104. For example, the thermolator 104 is configured to such as increase the temperature from 250 to 350 degree Centigrade, then dwell or maintain the temperature at 350 degrees centigrade.

FIG. 3 is another schematic representation of the system 100 of FIG. 1. The heat-exchange reservoir 105 is disconnected from the movable-mold portion 110 because the heat-exchange reservoir 105 has brought the thermal condition of the movable-mold portion 110 up to the desired thermal condition. The thermolator 104 is now operating to maintain the thermal condition of the movable-mold portion 110.

FIG. 4 is yet another schematic representation of the system 100 of FIG. 1. The thermal management system 101 may also include another thermolator 160 that is configured to manage thermal condition of the stationary-mold portion 120. The thermolator 160 is mounted to either the stationary platen 116 or to the movable mold portion 120.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. For a molding system, a thermal management system, comprising:
a thermolator trackable of a movement of a movable platen, the thermolator configured to heat a movable-mold portion supportable by the movable platen.

2. The thermal management system of claim 1, wherein the thermolator is fixedly mounted to the movable platen.

3. The thermal management system of claim 1, wherein the thermolator is fixedly mounted to the movable-mold portion.

4. The thermal management system of claim 1, wherein a thermal-management fluid is fluidly communicable between the thermolator and the movable-mold portion.

5. The thermal management system of claim 1, wherein the thermolator is configured to maintain thermal control of the movable-mold portion based on a closed loop control schema of a controller of the thermolator.

6. The thermal management system of claim 1, wherein the thermolator is configured to maintain control of the movable-mold portion based on a closed loop control schema of a controller of the thermolator, the controller having an input connectable to a temperature sensor, the temperature sensor connected to the movable-mold portion.

7. The thermal management system of claim 1, wherein a thermal-management fluid is fluidly communicable between:
the thermolator and the movable-mold portion, and
the thermolator and a heat-exchange reservoir.

8. The thermal management system of claim 1, wherein a thermal-management fluid is fluidly communicable between:
the thermolator and the movable-mold portion, and
the movable-mold portion and a heat-exchange reservoir.

9. The thermal management system of claim 1, wherein a thermal-management fluid is fluidly communicable between:
the thermolator and the movable-mold portion, and
the thermolator and a heat-exchange reservoir, the heat-exchange reservoir is configured to pump heat into the movable-mold portion, via the thermolator, the heat-exchange reservoir being disconnectable from the thermolator once the movable-mold portion reaches a temperature elevated above ambient temperature, the thermolator configured to manage thermal condition of the movable-mold portion once the heat-exchange reservoir is disconnected from the thermolator.

10. The thermal management system of claim 1, wherein a thermal-management fluid is fluidly communicable between:
the thermolator and the movable-mold portion, and
the movable-mold portion and a heat-exchange reservoir, the heat-exchange reservoir is configured to pump heat into the movable-mold portion, the heat-exchange reservoir being disconnectable from the thermolator once the movable-mold portion reaches a temperature elevated above ambient temperature, the thermolator configured to maintain thermal condition of the movable-mold portion once the heat-exchange reservoir is disconnectable from the thermolator.

11. A molding system, comprising:
an extruder;
a machine nozzle operatively mounted to the extruder;
a stationary platen cooperative with the extruder;
a movable platen movable relative to the stationary platen, the movable platen and the stationary platen configured to have a mold mounted thereto, the mold including:
a stationary-mold portion mounted to the stationary platen; and
a movable-mold portion mounted to the movable platen, the movable-mold portion and the stationary-mold portion defining a mold cavity, the movable-mold portion defining a gate leading to the mold cavity, the gate mating with the machine nozzle of the extruder; and
a thermal management system including a thermolator trackable of a movement of a movable platen, the thermolator configured to heat the movable-mold portion.

12. The molding system of claim 11, wherein the thermolator is fixedly mounted to the movable platen.

13. The molding system of claim 11, wherein the thermolator is fixedly mounted to the movable-mold portion.

14. The molding system of claim 11, wherein a thermal-management fluid is fluidly communicable between the thermolator and the movable-mold portion.

15. The molding system of claim 11, wherein the thermolator is configured to maintain thermal control of the movable-mold portion based on a closed loop control schema of a controller of the thermolator.

16. The molding system of claim 11, wherein the thermolator is configured to maintain control of the movable-mold portion based on a closed loop control schema of a controller of the thermolator, the controller having an input connectable to a temperature sensor, the temperature sensor connected to the movable-mold portion.

17. The molding system of claim 11, wherein a thermal-management fluid is fluidly communicable between:
the thermolator and the movable-mold portion, and
the thermolator and a heat-exchange reservoir.

18. The molding system of claim 11, wherein a thermal-management fluid is fluidly communicable between:
the thermolator and the movable-mold portion, and
the movable-mold portion and a heat-exchange reservoir.

19. The molding system of claim 11, wherein a thermal-management fluid is fluidly communicable between:
the thermolator and the movable-mold portion, and
the thermolator and a heat-exchange reservoir, the heat-exchange reservoir is configured to pump heat into the movable-mold portion, via the thermolator, the heat-exchange reservoir being disconnectable from the thermolator once the movable-mold portion reaches a temperature elevated above ambient temperature, the thermolator configured to manage thermal condition of the movable-mold portion once the heat-exchange reservoir is disconnected from the thermolator.

20. The molding system of claim 11, wherein a thermal-management fluid is fluidly communicable between:
the thermolator and the movable-mold portion, and
the movable-mold portion and a heat-exchange reservoir, the heat-exchange reservoir is configured to pump heat into the movable-mold portion, the heat-exchange reservoir being disconnectable from the thermolator once the movable-mold portion reaches a temperature elevated above ambient temperature, the thermolator configured to maintain thermal condition of the movable-mold portion once the heat-exchange reservoir is disconnectable from the thermolator.

21. A method of thermal management of a molding system, comprising:
tracking a thermolator to a movement of a movable platen, the thermolator configured to heat a movable-mold portion supportable by the movable platen.

22. The method of claim 21, further comprising:
fixedly mounting the thermolator to the movable platen.

23. The method of claim 21, further comprising:
fixedly mounting the thermolator to the movable-mold portion.

24. The method of claim 22, further comprising:
fluidly communicating a thermal-management fluid between the thermolator and the movable-mold portion.

25. The method of claim 21, further comprising:
maintaining thermal control of the movable-mold portion based on a closed loop control schema of a controller of the thermolator.

26. The method of claim 21, further comprising:
maintaining control of the movable-mold portion based on a closed loop control schema of a controller of the thermolator, the controller having an input connectable to a temperature sensor, the temperature sensor connected to the movable-mold portion.

27. The method of claim 21, further comprising:
fluidly communicating a thermal-management fluid between:
the thermolator and the movable-mold portion, and
the thermolator and a heat-exchange reservoir.

28. The method of claim 21, further comprising:
fluidly communicating a thermal-management fluid between:
the thermolator and the movable-mold portion, and
the movable-mold portion and a heat-exchange reservoir.

29. The method of claim 21, further comprising:
fluidly communicating a thermal-management fluid between:
the thermolator and the movable-mold portion, and
the thermolator and a heat-exchange reservoir; and
pumping heat into the movable-mold portion, via the thermolator, the heat-exchange reservoir being disconnectable from the thermolator once the movable-mold portion reaches a temperature elevated above ambient temperature, the thermolator configured to manage thermal condition of the movable-mold portion once the heat-exchange reservoir is disconnected from the thermolator.

30. The method of claim 21, further comprising:
fluidly communicating a thermal-management fluid between:
the thermolator and the movable-mold portion, and
the movable-mold portion and a heat-exchange reservoir; and
pumping heat into the movable-mold portion, the heat-exchange reservoir being disconnectable from the thermolator once the movable-mold portion reaches a temperature elevated above ambient temperature, the thermolator configured to maintain thermal condition of the movable-mold portion once the heat-exchange reservoir is disconnectable from the thermolator.
